(19) United States
(12) Patent Application Publication
(10) Pub. No.: US 2009/0261189 A1
(43) Pub. Date: Oct. 22, 2009

(54) SECURE, STREET-SIDE, PERSONAL INFORMATION, MAIL SHREDDER

(76) Inventor: William Rogers Ellis, JR., Moyock, NC (US)

Correspondence Address: WILLIAM ROGERS ELLIS JUNIOR, 175 SUMMIT FARMS TRAIL, MOYOCK, NC, 27958, US

(21) Appl. No.: 12/104,642

(22) Filed: Apr. 17, 2008

(51) Int. Cl. B02C 18/00

(52) U.S. Cl. 241/36; 241/100; 241/37.5; 320/101; 429/122

(57) ABSTRACT

A residential, street-side; secure information destruction or shredding system that allows an individual to deter identity theft quickly, personally and effectively by destroying documents and other mail items containing personal information. This secure, street-side, personal information, mail shredder is designed to be constructed in order to provide an environmentally sound housing, easily and securely attached, in a non-evasive manner, to a post, column, or any other type of unit designed to hold a street-side mailbox or attached to a post, column, or unit within reach of a street-side mailbox.

### RELATED APPLICATIONS

The present application is related to U.S. Pat. No. 3,682,402, issued Aug. 8, 1973, by Goldhammer, included by reference herein.

The present application is related to U.S. Pat. No. 3,724,766, issued Apr. 3, 1973, by Bosland, included by reference herein.

The present application is related to U.S. Pat. No. 3754498, issued Aug. 28, 1973, by Gil, included by reference herein.

The present application is related to U.S. Pat. No. 4,637,560, issued Jan. 20, 1987, by Goldhammer, included by reference herein.

The present application is related to U.S. Pat. No. 4,650,128, issued Mar. 17, 1987, by Goldhammer, included by reference herein.

The present application is related to U.S. Pat. No. 4,700,902, issued Nov. 20, 1987, by Yeomans, included by reference herein.

The present application is related to U.S. Pat. No. 4,821,967, issued Apr. 18, 1989, by Moriyama, included by reference herein.

The present application is related to U.S. Pat. No. 4,957,243, issued Sep. 18, 1990, by Kanagaki, included by reference herein.

The present application is related to U.S. Pat. No. 5,035,366, issued Jul. 30, 1991, by Hashimoto, included by reference herein.

The present application is related to U.S. Pat. No. 5,269,473, issued Dec. 14, 1993, by Strohmeyer, included by reference herein.

The present application is related to U.S. Pat. No. 5,429,313, issued Jul. 4, 1995, by Schwelling, included by reference herein.

The present application is related to U.S. Pat. No. 5,897,065, issued Apr. 27, 1999, by Schwelling, included by reference herein.

The present application is related to U.S. Pat. No. 6,079,645, issued Jun. 27, 2000, by Henreckson, included by reference herein.

The present application is related to U.S. Pat. No. 6,116,528, issued Sep. 12, 2000, by Schwelling, included by reference herein.

The present application is related to U.S. Pat. No. 6,682,006, issued Jan. 27, 2004, by Lee, included by reference herein.

The present application is related to U.S. Pat. No. 6,962,301, issued Nov. 8, 2005, by Chang, included by reference herein.

The present application is related to U.S. Pat. No. 6,964,386, issued Nov. 15, 2005, by Ho, included by reference herein.

The present application is related to U.S. Pat. No. 7,083,131, issued Aug. 1, 2006, by Ting, included by reference herein.

The present application is related to U.S. Pat. No. 7,104,481, issued Sep. 12, 2006, by Schenker, included by reference herein.

The present application is related to U.S. Pat. No. 7,213,777, issued May 8, 2007, by Podrovitz, included by reference herein.

### FIELD OF THE INVENTION

The present invention relates to shredding systems and devices used to destroy documents and other items and, more particularly, to a shredding system that is designed for personal use at a residence, within reach of a residential mailbox, that allows a user to use the system for destruction of documents and other personal items, such as credit cards, medical information, computer disks, credit card offers, and any other mail items containing personal information.

### BACKGROUND OF THE INVENTION

The President's Identity Theft Task Force, “Combating Identity Theft, A Strategic Plan”, states that “Criminals . . . gather personal information, either through low-tech methods-such as stealing mail or workplace records, or “dumpster diving”. The Strategic Plan lists two different ways, thieves use this personal information: Creation of new accounts and Compromising current accounts. Identity theft occurs in many different forms including: obtaining credit cards, renting apartments or homes and establishing other types of revolving credit. Thieves obtain personal information in several different ways including: Stealing wallets; mail, including bank and credit card statements; pre-approved credit offers; new checks; tax information; personal medical information; and bills.

Individuals often feel that they can counter these thieves by attempting to physically destroy the unwanted mail items, which come in the mail. Unfortunately, “torn” mail items can be pieced back together very similar to a puzzle. Identity thieves often have time on their hands to piece this identity puzzle back together. A significant side affect has developed in households in relation to identity theft is in the form of clutter. With the vast amount of mail received each day at a typical residence, it is difficult for most, to take the time and actually sit down and go through the mail items. In turn, the mail becomes clutter within the home and could possibly be thrown out with the trash. Most individuals have in-home shredders at their disposal. This is convenient to most and works well in some occasions, but there are other concerns, which could come into play. These concerns include: Unwanted access by children or pets, which could lead to physical harm and possibly jamming or destruction of the in-home shredder and dealing with the messy in-home shredder by-product.

Hence, there is a need for a street-side method or system to allow residential users to destroy, in a timely manner, documents and other media that may include personal information and may otherwise end up in the home as clutter would be advantageous to provide a residential, street-side; secure information destruction or shredding system that allows an individual to deter identity theft quickly, personally and effectively by destroying documents and other mail items containing personal information

It would also be advantageous to provide a residential, secure, street-side, personal information, mail shredder, which is designed to be easily and securely attached, in a non-evasive manner, to a post, column, or any other type of unit designed to hold a street-side mailbox or attached to a post, column, or unit within reach of a street-side mailbox

It would further be advantageous to provide an environmentally safe housing that contains an internally positioned shredder apparatus protected by a keyed shredder slot door protecting the feed chute and shredder head

It would further be advantageous to provide a feed chute to allows access to the shredding unit for shredding of credit cards, medical information, computer disks, credit card offers, and any other mail items containing personal information

It would further be advantageous to provide an outlet in order to feed shredded or destroyed personal material into a keyed disposable bag container located below the shredding unit

It would further be advantageous to provide a power switch to operate the shredding unit, which is in the off position when the keyed shredder slot door is closed and is turned on when the keyed shredder slot door is opened

It would further be advantageous to provide a solar panel for charging the 12 Volt Battery, which in turn powers the shredder apparatus motor

It would further be advantageous to provide an optional AC Connection to provide power to the shredder system or to charge the 12 Volt Battery

It would further be advantageous to provide an optional hand cranking lever to be used in case of power outage or as a stand-alone application

### SUMMARY OF THE INVENTION

In accordance with the present invention, there is provided a residential, street-side; secure information destruction or shredding system that allows an individual to immediately deter identity theft quickly, personally and effectively by destroying documents and other mail items containing personal information. This secure, street-side, personal information, mail shredder is designed to be easily and securely attached, in a non-evasive manner, to a post, column, or any other type of unit designed to hold a street-side mailbox or attached to a post, column, or unit within reach of a street-side mailbox. The system includes a solar panel to charge a 12 volt battery, an optional AC adapter to power the unit or to charge the 12 volt battery, a hand cranking lever to operate the system as a stand-alone unit incase of power outage, a housing that contains an internally positioned shredder apparatus protected by a keyed shredder slot door protecting the feed chute and shredder head. The feed chute allows access to the shredding unit for shredding of credit cards, medical information, computer disks, credit card offers, and any other mail items containing personal information. The outlet of the shredding apparatus feeds shredded or destroyed personal material into a locked storage bin located below the shredding unit.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram view of a secure, street-side, personal information, mail shredder;

FIG. 2 is a right view of a secure, street-side, personal information, mail shredder; and

FIG. 3 is a front view of a secure, street-side, personal information, mail shredder.

For purposes of clarity and brevity, like elements and components will bear the same designations and numbering throughout the Figures.

### DESCRIPTION OF THE PREFERRED EMBODIMENT

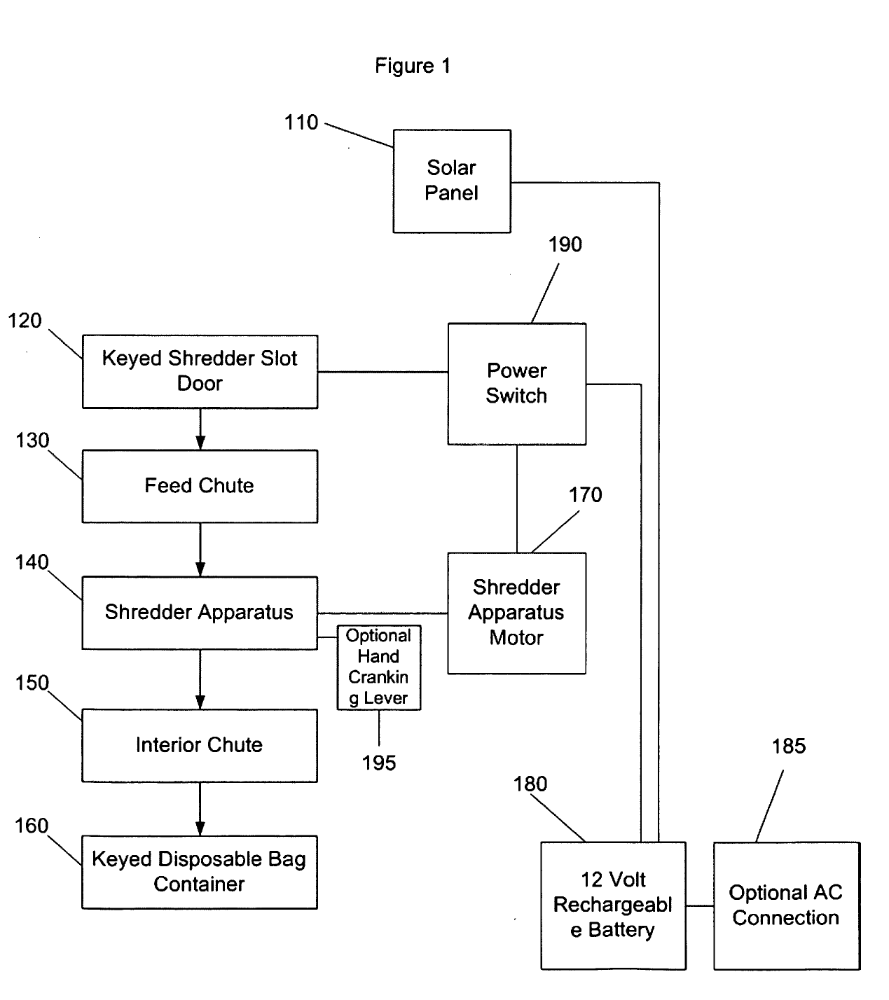

FIG. 1 is a block form view of an exemplary secure, street-side, personal information, mail shredder system 100. As shown, in this depiction, the secure, street-side, personal information, mail shredder system 100 includes a Solar Panel 110 for charging the 12 Volt Battery 180. The 12 Volt Battery 180 is used to power the Shredder Apparatus Motor 170. An optional AC connection 185 to charge the 12 Volt Battery 180 or to power the unit. An optional Hand Cranking Lever 195 to be used in case of power outage or as a stand-alone application. The Keyed Shredder Slot Door 120 is used to protect access to the Feed Chute 130, to engage the Power Switch 190 when opened and to ultimately protect the Shredder Apparatus 140. The Shredder Apparatus 140 is powered on when the Keyed Shredder Slot Door 120 is unlocked with a key and opened. Once the Keyed Shredder Slot Door 120 is unlocked and opened, the user can then place unwanted credit cards, medical information, computer disks, credit card offers, and any other mail items containing personal information into the Feed Chute 130 to be destroyed.

The Feed Chute 130 exposes a feed inlet to the user for feeding or inputting credit cards, medical information, computer disks, credit card offers, and any other mail items containing personal information for shredding and directs the materials into the Shredder Apparatus 140. Once unwanted credit cards, medical information, computer disks, credit card offers, and any other mail items containing personal information is placed in the Feed Chute 130, the items are destroyed by the Shredder Apparatus 140. The destroyed credit cards, medical information, computer disks, credit card offers, and any other mail items containing personal information are then passed through the Interior Chute 150 to an inlet of the Keyed Disposable Bag Container 160. Once the user is finished using the secure, street-side, personal information, mail shredder system 100, the user will then close the Keyed Shredder Slot Door 120, which turns off the shredder by depressing the Power Switch 190, and lock the Keyed Shredder Slot Door 120 with the Keyed Shredder Slot Door 120 key. Once the Keyed Disposable Bag Container 160 is full, the user will use the Keyed Shredder Slot Door 120 key to unlock the Keyed Disposable Bag Container 160 and remove the shredded material.

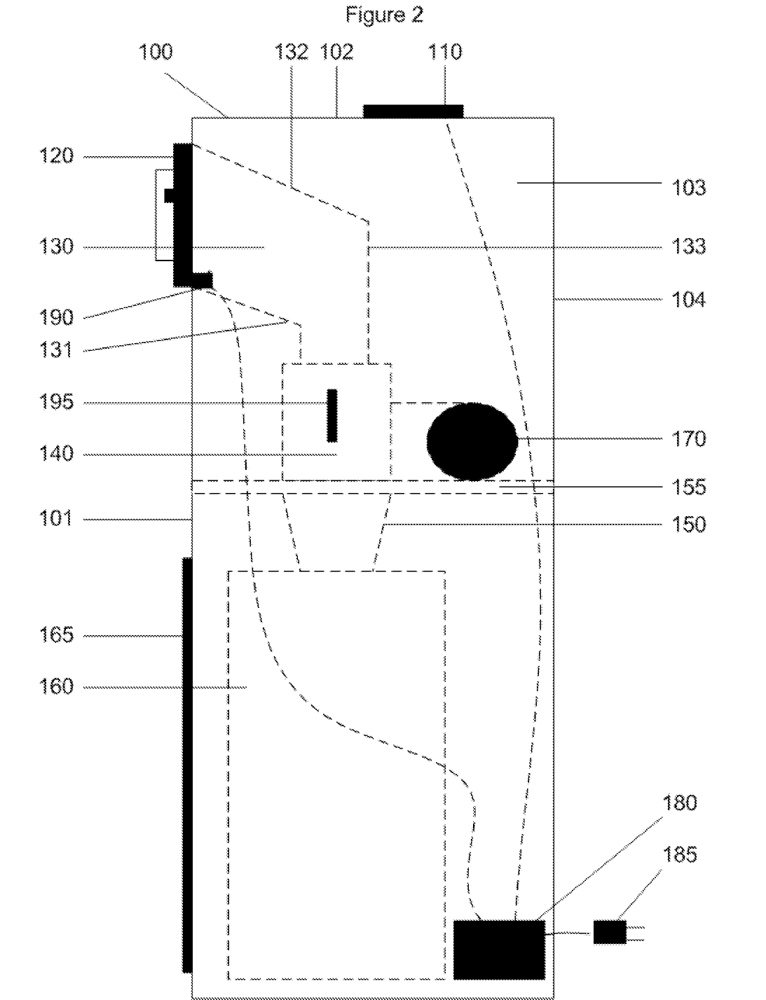

FIG. 2 is a front view of a residential, street-side; secure information destruction or shredding system. The secure, street-side, personal information, mail shredder system 100 includes an environmentally sound cabinet with a Front Panel 101, Side Panel 103, Top Panel 102, Back Panel 104, Keyed Shredder Slot Door 120 and a Keyed Disposable Bag Container Door 165. The housing also includes a Feed Chute 130 that is made up of a Feed Chute Housing Bottom Wall 131, Feed Chute Housing Top Wall 132 and a Feed Chute Housing Rear Wall 133. Located between the Shredder Apparatus 140 is the Interior Chute 150 connecting the Shredder Apparatus 140 to the Keyed Disposable Bag Container 160. An optional hand cranking lever 195 to be used in case of power outage or as a stand-alone application.

The secure, street-side, personal information, mail shredder system 100 includes a Keyed Disposable Bag Container 160 for storing the shredded materials, which includes a Keyed Disposable Bag Container Door Lock 175 to provide security and a Keyed Shredder Slot Door 120 which includes a Keyed Shredder Slot Door Lock 121 to provide security and safe access to the Shredder Apparatus 140. The housing includes an interior shelf 155 upon which the Shredder Apparatus 140 and the Shredder Apparatus Motor 170 is positioned between the Feed Chute 130 and the Keyed Disposal Bag Container.

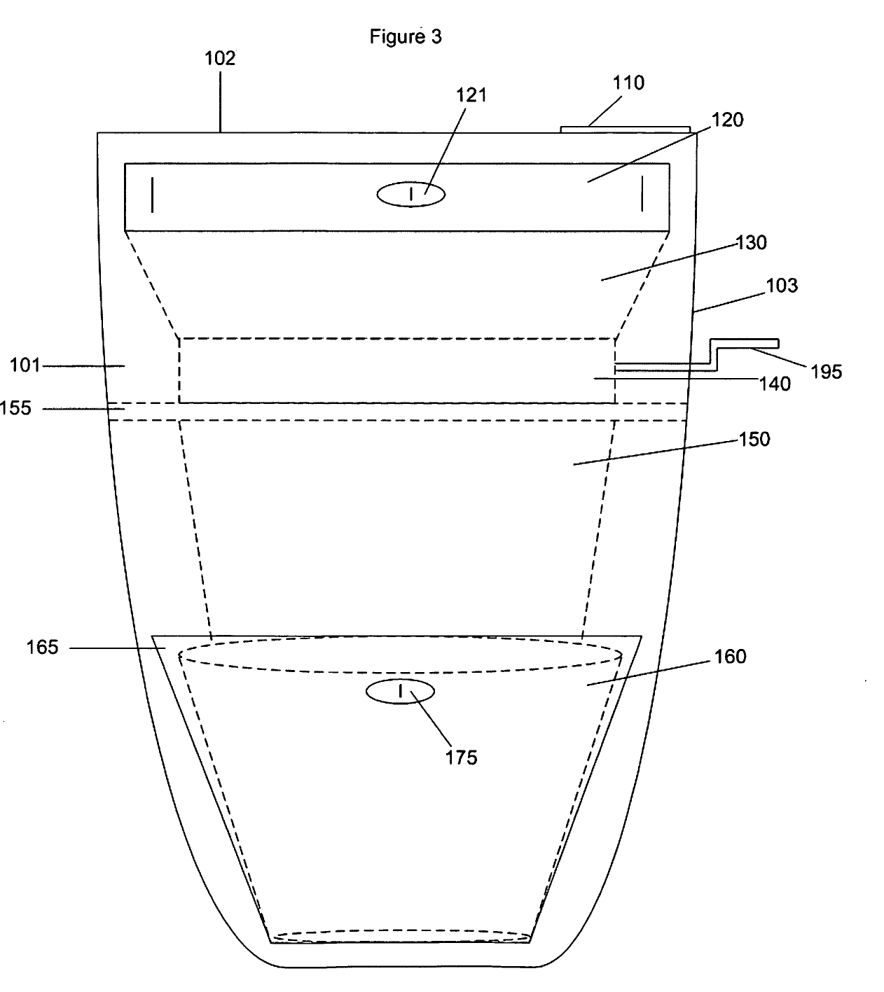

FIG. 3 is a right sectional view of a residential, street-side; secure information destruction or shredding system. The secure, street-side, personal information, mail shredder system 100 also includes a Power Switch 190 located between the Keyed Shredder Slot Door 120 and the Front Panel 101 in order to turn the secure, street-side, personal information, mail shredder system 100 on and off. Located on the Top Panel 102 of the secure, street-side, personal information, mail shredder system 100 is the Solar Panel 110 which will charge the 12 Volt Battery 180.

The 12 Volt Battery 180 will provide power to the Shredder Apparatus Motor 170 through the use of the Power Switch 190. The Shredder Apparatus Motor 170 will be used to power the Shredder Apparatus 140.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A secure, street-side, personal information, mail shredder for residential street-side application used for destroying mail items, which may contain personal information, comprising:
means for charging the 12 volt battery;
means for powering the shredder apparatus motor;
means for shredding credit cards, medical information, computer disks, credit card offers, and any other mail items containing personal information;
means for charging the 12 volt battery or powering the unit without the use of the solar panel or 12 volt battery;
means for use in case of power outage or as a stand-alone application when battery, electric, or solar power is not available;
means for protecting access to the feed chute;
means for exposing a feed inlet to the user for feeding or inputting credit cards, medical information, computer disks, credit card offers, and any other mail items containing personal information for shredding and directs the materials into the shredder apparatus;
means for turning the shredder apparatus on and off;
means for shredding unwanted credit cards, medical information, computer disks, credit card offers, and any other mail items containing personal information;
means for providing access to the keyed disposable bag container for the shredded credit cards, medical information, computer disks, credit card offers, and any other mail items containing personal information;
means for collecting the shredded credit cards, medical information, computer disks, credit card offers, and any other mail items containing personal information;
means for providing a front panel to the shredding system;
means for providing an interior shelf for the shredder apparatus and shredder apparatus motor to be mounted;
means for providing secure access to the keyed disposable bag container;
means for providing a top panel to the shredding system;
means for providing a means to provide secure access to the shredder apparatus;
means for providing a side panel to the shredding system;
means for providing a bottom wall for the feed chute;
means for providing a top wall for the feed chute;
means for providing a rear wall for the feed chute;
means for providing a back panel to the shredding system;
means for providing a secure, street-side, personal information, mail shredder;
and
means for providing a means to provide secure access to the disposable bag container.

2. The secure, street-side, personal information, mail shredder in accordance with claim 1, wherein said means for charging the 12 volt battery comprises a solar panel.

3. The secure, street-side, personal information, mail shredder in accordance with claim 1, wherein said means for powering the shredder apparatus motor comprises a rechargeable 12 volt battery.

4. The secure, street-side, personal information, mail shredder in accordance with claim 1, wherein said means for shredding credit cards, medical information, computer disks, credit card offers, and any other mail items containing personal information comprises a shredder apparatus motor.

5. The secure, street-side, personal information, mail shredder in accordance with claim 1, wherein said means for charging the 12 volt battery or powering the unit without the use of the solar panel or 12 volt battery comprises an optional ac connection.

6. The secure, street-side, personal information, mail shredder in accordance with claim 1, wherein said means for use in case of power outage or as a stand-alone application when battery, electric, or solar power is not available comprises an optional hand cranking lever.

7. The secure, street-side, personal information, mail shredder in accordance with claim 1, wherein said means for protecting access to the feed chute comprises a keyed shredder slot door.

8. The secure, street-side, personal information, mail shredder in accordance with claim 1, wherein said means for exposing a feed inlet to the user for feeding or inputting credit cards, medical information, computer disks, credit card offers, and any other mail items containing personal information for shredding and directs the materials into the shredder apparatus comprises a feed chute.

9. The secure, street-side, personal information, mail shredder in accordance with claim 1, wherein said means for turning the shredder apparatus on and off comprises a power switch.

10. The secure, street-side, personal information, mail shredder in accordance with claim 1, wherein said means for shredding unwanted credit cards, medical information, computer disks, credit card offers, and any other mail items containing personal information comprises a shredder apparatus.

11. The secure, street-side, personal information, mail shredder in accordance with claim 1, wherein said means for providing access to the keyed disposable bag container for the shredded credit cards, medical information, computer disks, credit card offers, and any other mail items containing personal information comprises an interior chute.

12. The secure, street-side, personal information, mail shredder in accordance with claim 1, wherein said means for collecting the shredded credit cards, medical information, computer disks, credit card offers, and any other mail items containing personal information comprises a keyed disposable bag container.

13. The secure, street-side, personal information, mail shredder in accordance with claim 1, wherein said means for providing an interior shelf for the shredder apparatus and shredder apparatus motor to be mounted comprises an interior shelf.

14. The secure, street-side, personal information, mail shredder in accordance with claim 1, wherein said means for providing secure access to the keyed disposable bag container comprises a keyed disposable bag container door.

15. The secure, street-side, personal information, mail shredder in accordance with claim 1, wherein said means for providing a means to provide secure access to the shredder apparatus comprises a keyed shredder slot door lock.

16. The secure, street-side, personal information, mail shredder in accordance with claim 1, wherein said means for providing a secure, street-side, personal information, mail shredder comprises a shredder system.

17. The secure, street-side, personal information, mail shredder in accordance with claim 1, wherein said means for providing a means to provide secure access to the disposable bag container comprises a keyed disposable bag container door lock.

18. A secure, street-side, personal information, mail shredder for residential street-side application used for destroying mail items, which may contain personal information, comprising:
a solar panel, for charging the 12 volt battery;
a rechargeable 12 volt battery, for powering the shredder apparatus motor;
a shredder apparatus motor, for shredding credit cards, medical information, computer disks, credit card offers, and any other mail items containing personal information;
an optional ac connection, for charging the 12 volt battery or powering the unit without the use of the solar panel or 12 volt battery;
an optional hand cranking lever, for use in case of power outage or as a stand-alone application when battery, electric, or solar power is not available;
a keyed shredder slot door, for protecting access to the feed chute;
a feed chute, for exposing a feed inlet to the user for feeding or inputting credit cards, medical information, computer disks, credit card offers, and any other mail items containing personal information for shredding and directs the materials into the shredder apparatus;
a power switch, for turning the shredder apparatus on and off;
a shredder apparatus, for shredding unwanted credit cards, medical information, computer disks, credit card offers, and any other mail items containing personal information;
an interior chute, for providing access to the keyed disposable bag container for the shredded credit cards, medical information, computer disks, credit card offers, and any other mail items containing personal information;
a keyed disposable bag container, for collecting the shredded credit cards, medical information, computer disks, credit card offers, and any other mail items containing personal information;
a front panel, for providing a front panel to the shredding system;
an interior shelf, for providing an interior shelf for the shredder apparatus and shredder apparatus motor to be mounted;
a keyed disposable bag container door, for providing secure access to the keyed disposable bag container;
a top panel, for providing a top panel to the shredding system;
a keyed shredder slot door lock, for providing a means to provide secure access to the shredder apparatus;
a side panel, for providing a side panel to the shredding system;
a feed chute housing bottom wall, for providing a bottom wall for the feed chute;
a feed chute housing top wall, for providing a top wall for the feed chute;
a feed chute housing rear wall, for providing a rear wall for the feed chute;
a back panel, for providing a back panel to the shredding system;
a shredder system, for providing a secure, street-side, personal information, mail shredder; and
a keyed disposable bag container door lock, for providing a means to provide secure access to the disposable bag container.

19. A secure, street-side, personal information, mail shredder for residential street-side application used for destroying mail items, which may contain personal information, comprising:
a solar panel, for charging the 12 volt battery;
a rechargeable 12 volt battery, for powering the shredder apparatus motor;
a shredder apparatus motor, for shredding credit cards, medical information, computer disks, credit card offers, and any other mail items containing personal information;
an optional ac connection, for charging the 12 volt battery or powering the unit without the use of the solar panel or 12 volt battery;
an optional hand cranking lever, for use in case of power outage or as a stand-alone application when battery, electric, or solar power is not available;
a keyed shredder slot door, for protecting access to the feed chute;
a feed chute, for exposing a feed inlet to the user for feeding or inputting credit cards, medical information, computer disks, credit card offers, and any other mail items containing personal information for shredding and directs the materials into the shredder apparatus;
a power switch, for turning the shredder apparatus on and off;
a shredder apparatus, for shredding unwanted credit cards, medical information, computer disks, credit card offers, and any other mail items containing personal information;
an interior chute, for providing access to the keyed disposable bag container for the shredded credit cards, medical information, computer disks, credit card offers, and any other mail items containing personal information;
a keyed disposable bag container, for collecting the shredded credit cards, medical information, computer disks, credit card offers, and any other mail items containing personal information;
a front panel, for providing a front panel to the shredding system;
an interior shelf, for providing an interior shelf for the shredder apparatus and shredder apparatus motor to be mounted;
a keyed disposable bag container door, for providing secure access to the keyed disposable bag container;
a top panel, for providing a top panel to the shredding system;
a keyed shredder slot door lock, for providing a means to provide secure access to the shredder apparatus;
a side panel, for providing a side panel to the shredding system;
a feed chute housing bottom wall, for providing a bottom wall for the feed chute;
a feed chute housing top wall, for providing a top wall for the feed chute;
a feed chute housing rear wall, for providing a rear wall for the feed chute;
a back panel, for providing a back panel to the shredding system;
a shredder system, for providing a secure, street-side, personal information, mail shredder; and
a keyed disposable bag container door lock, for providing a means to provide secure access to the disposable bag container.
